(19) United States
(12) Patent Application Publication
(10) Pub. No.: US 2006/0155605 A1
(43) Pub. Date: Jul. 13, 2006

(54) Rich media personal selling system

(76) Inventors: Peter Haighton, Ontario (CA); Donald Guy McLeod, Ontario (CA); Henri Van Rooyen, Ontario (CA)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/527,143

(22) PCT Filed: Sep. 10, 2003
(86) PCT No.: PCT/CA03/01321

§ 371 Date: Oct. 21, 2005

Related U.S. Application Data
(60) Provisional application No. 60/409,201, filed on Sep. 10, 2002.

(51) Int. Cl. G06Q 30/00

(52) U.S. Cl. 705/26

(57) ABSTRACT

The present invention provides a system and method for providing a sales professional with the ability to create and tailor web-sites comprising rich media content for a potential customer. In this manner a potential customer is presented with a personalised sales message thereby possibly increasing the potential for a sale. The present invention provides an end-to-end integrated system enabling this procedure. Initially, the system enables the obtaining of information relating to potential customers (end users) who may be directed to a personalised sales web-site. Using this collected information and previously collected customer information from other sources or previous interactions, the system creates and directs a potential customer to a personalized web-site for the particular sales campaign. During a customer's interaction with the personalized sales web-site, information relating to this customer is additionally collected and stored within the system enabling the system to personalize future sales campaigns directed to this particular customer. Optionally, the system may also be used in a web-conference, simplifying the experience of rich media and posting progress on the personalised sales web-site, thereby potentially enabling other members of the sales team to be aware of client interactions through the access of this personalised sales web-site.

### FIELD OF THE INVENTION

The present invention pertains to the field of selling systems, in particular to selling systems incorporating rich media

### BACKGROUND

Communication systems for interacting with clients personally have dramatically changed time-intensive aspects of a sales professional's job. Email allows a sales person to interact personally with a client, without travel. Digital video systems allow a sales person to create simple video messages for clients. Sales automation and customer-relationship management software integrate documents and information into the sales process. Web demonstrations allow a sales professional to point customers to an experience of the product they are selling. As well, online advertising has matured to where it can be used as part of a personal selling strategy.

Sales people need to filter information for their clients. Similarly, in advertising, it is considered highly desirable to target advertisements to the appropriate potential customer base, rather than to broadcast advertisements in general. It has long been known that, for example, advertisements for computers should generally not appear in magazines on gardening and, conversely, advertisements for gardening tools should not appear in magazines on computers. Similarly, advertisers have generally targeted their advertisements on television to programs appropriate for the desired customer base. Personal selling systems have evolved to help sales professionals target messages to clients.

It has also long been known that an advertisement that is repeated too often will eventually become ignored by consumers. Therefore, an advertiser typically wishes to eliminate duplication and reach as many individuals in the advertiser's target group as possible.

The development of on-line networks, such as America On-Line™, Compuserve™, and the Internet, has led to “on-line” advertising. For example, on the Internet, such on-line advertisements can appear on a web page as a banner on the top or the bottom thereof, for example. When a user views a web page using a browser such as Internet Explorer™ or Netscape™, the banner appears at the appropriate location and the user may then try to find out more information regarding the advertisement by selecting the advertisement (clicking through on that banner) through the use of the mouse or other pointing device. This action typically causes a HTTP message to be generated by the browser using the information encapsulated in association with the banner to send a request for an object with a given URL address to a different appropriate web site to access, for example, the advertiser's home page. As such the user is directed to this new web page, for example.

Nonetheless, such advertising has had, so far, a poor rate of response because it is typically untargeted advertising. Thus, someone who is totally uninterested in computers other than the fact that they happen to be on the Internet, may continually see advertisements for computers. On the other hand, someone who is interested in computers may continually see advertisements for gardening tools when browsing through a particular web site. If a user of such computer networks is continuously exposed to the same advertisement, the response rate to the advertisement will generally decline. In addition, it is also important for the advertisers to track responses to the advertisements and to acquire as much information about those people responding to the advertisements for targeting those same people at later dates regarding similar or the same products, for example. Making matters worse, there is a wide variety of digital media employed in corporations for use in marketing—web based training, web demonstrations, multimedia brochures, interactive web-tools and web services, digital video, streaming audio and video, for example. But the availability of corporate rich-media marketing messages has not necessarily helped people whose job it is to interact personally with clients, since the lack of targeted sales messages makes it difficult for a sales professional to do their job.

In particular U.S. Pat. No. 5,948,061 provides methods and apparatuses for targeting the delivery of advertisements over a network such as the Internet. Statistics are compiled on individual users, networks and the use of the advertisements is tracked to permit targeting of the advertisements of individual users. In response to requests from affiliated sites, an advertising server transmits to people accessing the page of a site an appropriate one of the advertisements based upon profiling of users and networks. To effect such a capability, an advertising server process is provided as a node on the network. The various advertisements are stored on the network of the server and preferably on the server. When, for example, a user using a web browser accesses a web page that is affiliated with the advertising server process, the affiliated page's encoding includes an embedded reference to an object provided by the advertising server process. This causes the user's browser to contact the advertising server process to provide the advertising image or information that will appear on the accessed web page as displayed by the user's browser. Using the address information and/or other information passed by the browser for the user, including the page being accessed by the user, the advertising server process determines an appropriate advertisement to select for presentation to the particular user. In addition, the advertising server process will use information such as the number of times the user has seen various advertisements, how often the advertisement has been seen by any user and the start and stop date for the various advertisements in order to select which advertisement to transmit to the user's web page for display. By compiling the information on networks and user selections, the advertising server process is able to compile information that can be used for targeting the advertising to the appropriate users.

In addition United States Patent Application No. 2002/0094868 provides a method, system and apparatus for interactive Internet advertising. This application discloses an apparatus, system and method for delivering rich-media advertising over the Internet including viewer tracking, an online sales interface and integration with the advertiser/retailer. The rich-media advertising of the invention includes full stereo audio, video and animation capabilities. The viewer tracking feature includes demographics of the viewer, geographic location, timing and viewer habits. The online sales interface of the invention includes options to buy online, options to leave the host web-site, options to print promotional offers, mapping tools and options to view other advertiser's promotional offers with search capability.

Each of the above systems provide a means for directing marketing to potential customers which are of a particular demographic thereby potentially increasing the probability of a sale. However, these systems do not take into account a particular customer's preferences enabling improved selection of potential customers for a sales campaign and modification and personalisation of a sales presentation, for example a web-site, for a particular potential customer.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a rich media personal selling system. In accordance with an aspect of the present invention, there is provided a method for generating a personalised sales web-site for an end user, said method comprising the steps of: generating a custom web-site for a particular sales campaign, said custom web-site enabling electronic access by the end user; collecting and storing one or more first events, said first events defining the end user's interaction with the custom web-site; generating a personalised sales web-site, said personalised sales web-site being a web-site created according to parameters based on the collected first events and the particular sales campaign; sending a message including an identifier to the end user, said identifier enabling the end user to locate the personalised sales web-site, the end user subsequently being able to electronically access the personalised sales web-site; and collecting and storing one or more second events, said second events defining the end user's interaction with the personalised sales web-site; wherein the collected and stored first and second events can be used to generate a second personalised sales web-site.

In accordance with another aspect of the invention, there is provided a computer readable medium containing program instructions for execution on a computer system, which when executed by the computer system causes the computer system to perform method steps for delivering, via a global communication network, a personalised sales web-site to an end user, said method comprising the steps of: generating a custom web-site for a particular sales campaign, said custom web-site enabling electronic access by the end user; collecting and storing one or more first events, said first events defining the end user's interaction with the custom web-site; generating a personalised sales web-site, said personalised sales web-site being a web-site created according to parameters based on the collected first events and the particular sales campaign; sending a message including an identifier to the end user, said identifier enabling the end user to locate the personalised sales web-site, the end user subsequently being able to electronically access the personalised sales web-site; and collecting and storing one or more second events, said second events defining the end user's interaction with the personalised sales web-site; wherein the collected and stored first and second events can be used to generate a second personalised sales web-site.

In accordance with another aspect of the invention, there is provided a system for generating a personalised sales web-site for an end user, said system comprising: means for generating a custom web-site for a particular sales campaign, said custom web-site enabling electronic access by the end user; means for collecting and storing one or more first events, said first events defining the end user's interaction with the custom web-site; means for generating a personalised sales web-site, said personalised sales web-site being a web-site created according to parameters based on the collected first events and the particular sales campaign; means for sending a message including an identifier to the end user, said identifier enabling the end user to locate the personalised sales web-site, the end user subsequently being able to electronically access the personalised sales web-site; and means for collecting and storing one or more second events, said second events defining the end user's interaction with the personalised sales web-site; wherein the collected and stored first and second events can be used to generate a second personalised sales web-site.

### BRIEF DESCRIPTION OF THE FIGURES

FIG. 1 is a schematic of the system according to one embodiment of the present invention.

FIG. 2 is a schematic of the system server according to one embodiment of the present invention.

FIG. 3 is a flow diagram for the sequence of events for creating a rich media sales campaign according to one embodiment of the present invention.

FIG. 4 is a flow diagram for the sequence of events for communicating with rich media according to one embodiment of the present invention.

### DETAILED DESCRIPTION OF THE INVENTION

Definitions

The term “rich media” is used to define various combinations of video, graphics, text messages or similar features as would be readily understood by a worker skilled in the art.

The term “customer relationship management (CRM) system” is used to define a system that assists in the automation of interactions between customers and a sales organisation. A CRM system can store and collect information relating to these interactions and this type of system can integrate large amounts of data around the task of selling, servicing or supporting potential and existing customers.

The term “lead generation system” is used to define a system that collects contact information about potential customers. This contact information can take a plurality of forms for example, name, address, email, telephone numbers and can also include information relating to a potential customers' purchasing habits and the like, for example.

The term “streaming system” is used to define a system which enables the transmission of information over a network to a destination site. As would be known to a worker skilled in the art, one method of streaming information can be performed by breaking the complete set of information into packets which arrive at a destination site at varying times. This method of streaming can enable the commencement of the “viewing” of the information prior to the completion of the transmission of the information to the destination site.

The term “email system” is used to define a system which enables the transmission of electronic messages over a communication network, for example the Internet or a satellite network.

The term “web conferencing system” is used to define a system which enables two or more users to interact over a network, wherein these users can be provided with the ability to view the same sharing information and interact with this information. With respect to this invention the web conferencing system can enable a sales professional to interact with a potential customer in a personal and remote manner, while providing information regarding the products for example.

The term “sales professional” is used to define a sales representative as would be known to a worker skilled in the art.

The term “end user” is used to define a potential customer, to which a personalised sales web-site according to the present invention, is directed. “End user”, “customer” and “potential customer” may be used interchangeably.

Unless defined otherwise, all technical and scientific terms used herein have the same meaning as commonly understood by one of ordinary skill in the art to which this invention belongs.

The present invention provides a system and method for providing a sales professional with the ability to create and tailor web-sites comprising rich media content for a potential customer. In this manner a potential customer is presented with a personalised sales message thereby increasing the potential for a sale. The present invention provides an end-to-end integrated system enabling this procedure. Initially, the system provides a means for the creation of a first web-site for obtaining information relating to potential customers for whom a personalised sales web-site may be created. This first web-site comprises information relating to a particular sales campaign and incorporates a means for collecting data relating to the one or more potential customers. Using this collected information and if available, previously collected customer information from other sources or previous customer interactions, the system creates and directs a potential customer to a personalised sales web-site for the particular sales campaign. During a customer's interaction with the personalised sales web-site, information relating to this customer is additionally collected and stored within the system enabling the system to direct future personalised sales campaigns and/or web-sites to this particular customer. Optionally, depending on a customer's interaction with the personalised sales web-site a web-conference may be initiated in order to provide a personal and remote interaction between a sales professional and a potential customer.

In one embodiment of the present invention, the information being sent to a potential customer is interactive and built on proven sales methodologies. As such the content of the personalised web-site can be based on the knowledge of the target market or end user and the appropriate sales methodology for this target market, wherein this content is built into modules wherein interactive modules are dynamically reconfigurable based on the end user information from the CRM system and the other modules are not modified. For example, when the end user is provided with the location of the personalised web-site and activates an interactive module, the system server will contact the CRM system and based on the information directly associated with the particular end user, the system server will dynamically configure the personalised web-site or piece of rich media content for this specific end user.

In one embodiment, for example, an end user can be defined by title, industry and company size based on the number of employees. When the end user initiates access to the personalised web-site, the system server can contact the CRM system in order to configure the content for that particular title, industry and company size. As such once the end user activates an interactive module the system server can determine, based on the information obtained from the CRM system, the type of information that is be displayed. For example, having regard to the specific product being sold in the particular sales campaign, if the CRM system indicates that the end user is in the software industry, the interactive module will display a customer testimonial for this product which has been provided by another software company if the end user requests a customer testimonial. In addition, if the end user is a clothing company, this requested testimonial for the particular product that is from a clothing manufacturer, for example. All of the information collected during this interaction between the system according to the present invention and an end user is recorded by the system server and stored in the CRM system. As such this collected information can be processed, and based on success rates, for example sales, the content can be upgraded or modified based on this collected information.

In one embodiment of the invention, the interactive modules can aid in the identification of an end user's goals, problems, the impact of the problems, the impact if the problems are solved and a type of return on investment (ROI) calculation or solution, for example. As the end user makes choices between different goals, problems, impacts of problems, impact if the problems are solved and ROI calculators or other solutions, the system server can respond differently in order to personally engage with that end user. In addition, as a sales professional receives this end user information from the interaction of the end user and the system, which is stored in the CRM system, the sales professional can be capable of determining what the end user requires and why the end user needs particular solution even before the first face to face meeting. Therefore time may not be wasted trying to sell a solution for which an end user has no need. In addition, sales professionals can therefore limit their visits to end users with a real need for their product or service and speak to them about those needs, thereby assuming the role of a consultant that helps to advance the end user's business, for example. The fact that the salesperson is able to focus on solving the end user's problems can make the salesperson more likely to accomplish a sale.

In one embodiment of the invention the system determines the identity of an end user by centring communications between the system and the end user around an email address or similar personal identifier of an end user. As such, the system identifies a particular end user by this form of personal parameter. In this manner discrete users can be identified rather than a device or location through the use of an IP address or a particular device identification, for example, thereby resulting in a more appropriate targeting of a particular sales campaign. For example, if a sales campaign is directed to a particular IP address or a particular device, the user of this device at the time of receipt of the sales presentation may not be the intended target, thereby reducing the effectiveness of the customisation of the sales presentation or web-site.

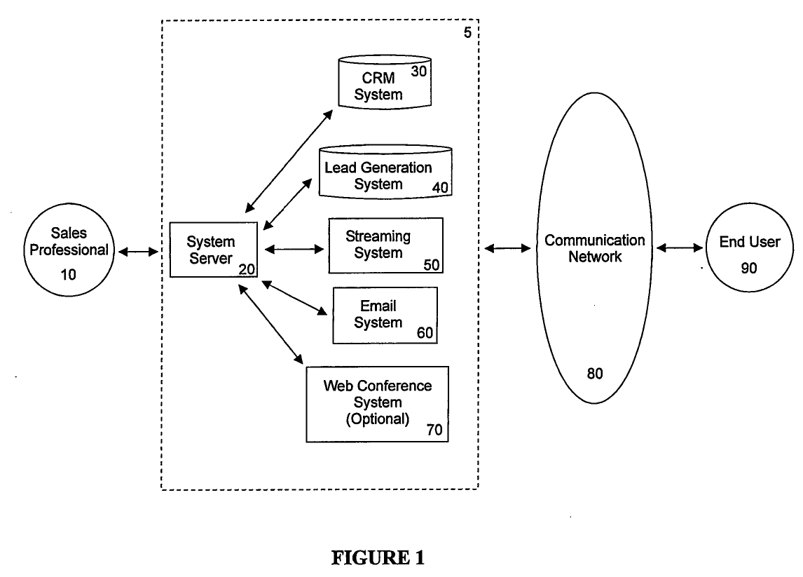

The system according to the present invention incorporates a number of different components that are integrated together in order to provide the system with its functionality. This system is used by a sales professional 10 in order to effectively direct sales campaigns to an end user 90. In one embodiment and with reference to FIG. 1, the system 5 comprises: a system server 20, wherein the system server co-ordinates the functionality of the components of the system; an email system 60 for enabling the transmission of electronic messages to end users 90; a streaming system 50 for enabling the transmission of information to the end users 90; and a customer relationship management system 30 or a lead generation system 40 or both, wherein these systems provide a means for collecting and analysing information on a plurality of end users. This information can be collected during an end user's interaction with the system or other means, for example. This collection of information reflective of a particular end user enables the subsequent personalisation of a web-site for access by the particular end user 90. Optionally, the system of the present invention may further comprise a web conferencing system 70 thereby providing a personal and remote interaction between a sales professional 10 and an end user 90. For example, a web conference can be initiated if a particular end user has requested additional information relating to the product or products presented on the personalised web-site.

Information is transmitted to an end user 90 using a communication network, wherein this communication network is a type of global communication network for example the Internet or World Wide Web, a satellite network, cellular network or any other global communication network as would be known to a worker skilled in the art.

In one embodiment of the invention, the functionality of the system is provided by a single computing device, wherein the functionality of each component of the system is provided thereby, and these components of the system can be embodied as computer programs executed by the computing device. In an alternate embodiment, the system may comprise a number of computing devices, wherein the functionality of the system is divided among a collection of computing devices. In this embodiment the appropriate computing program or programs which embody the one or more components of the system, are installed and executed on the appropriate computing device. A computing device which may be used in association with this invention may be for example a personal computer, a server computer, a main frame computer, or a combination thereof, or any other type of computing device as would be known to a worker skilled in the art. A computing device associated with the present invention is capable of direct or indirect interconnection with the one or more communication networks that are utilised by the system of the present invention.

In an embodiment where multiple computing devices provide the system with its functionality, these devices can be interconnected by an additional communication network wherein this communication network may be a local area network, a wide area network, a hardwired or wireless network or a combination thereof or any other type of communication network as would be know to a worker skilled in the art. In one embodiment, the network interconnecting the multiple computing devices forming the system may be the Internet or any other type of global communication network as would be known to a worker skilled in the art. The use of a global network as this communication network may enable a number of sales professionals to access a central CRM system, for example. By having a central CRM system a more global customer database can be compiled during a customer's interaction with the system. This type of configuration can comprises a number of satellite system servers that provide the functionality of the present invention, however the central CRM system is remotely accessed by each satellite system server. As such, this type of configuration can enable a plurality of sales professionals to direct sales campaigns to potential customers that have not interacted with a particular satellite system server, but has interacted with another satellite system server, thereby increasing the ability to target appropriate potential customers with a particular sales campaign.

System Server

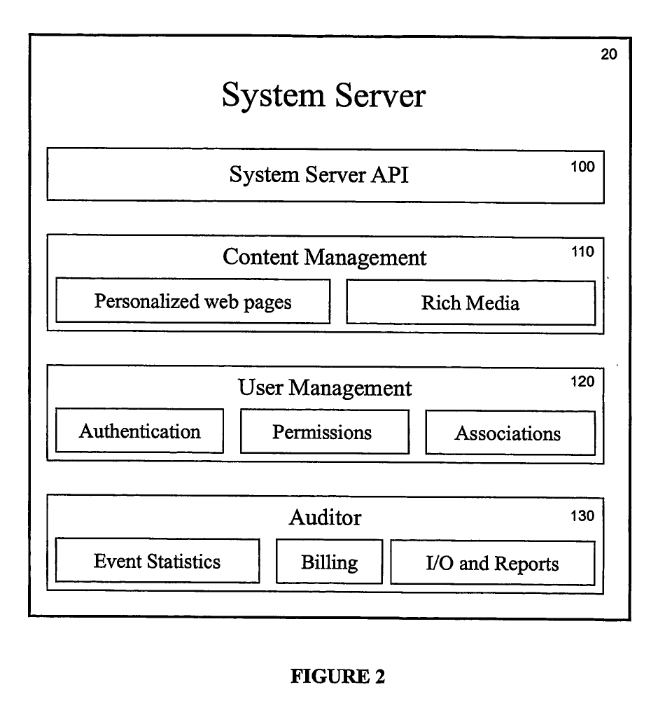

In one embodiment of the present invention and with reference to FIG. 2, the system server 20 is formed from a collection of modules comprising a system server application program interface (API) module 100, a content management module 110, a user management module 120 and an auditor module 130. The system server API 100 provides interfaces between the applications of the system server, for example the content management system and the operating system of the computing device upon which the computer program is being executed. The content management system 110 enables the system to manage the distribution, identity and location of the generated personalised web pages and the rich media used by the system, for example the multimedia sales messages. The user management system 120 provides a means for establishing the authentication, permission and associations of allowable system users (sales professionals). For example, the user management system can incorporate a login sequence for enabling the verification of a system user and may also establish the authorisation of a particular system user to access all or only portions of the information which is contained on the system server 20. This may be accomplished through the use of passwords or bio-identifiers like fingerprints and the like, for example. The user management system can also manage the persistence and statefulness that allow multiple sessions to be bound to the same identity. That is, the network used by this invention is stateless. The system server tracks events across multiple sessions, and associates them with a user. It can display this information when called upon, for example in the personalised web-site it creates, wherein aspects of a previous web-conference or viewing experience may by displayed on the personalised web-site. The system server 20 further comprises an auditor 130 which compiles information relating to event statistics, for example end user interaction with the system. The system server can additionally compile information relating to billing and input/output and reports. In this manner the effectiveness of the system can be evaluated in addition to identifying end users that are more likely to purchase the item(s) or service(s) being presented, for example.

Creating a Rich Media Sales Campaign

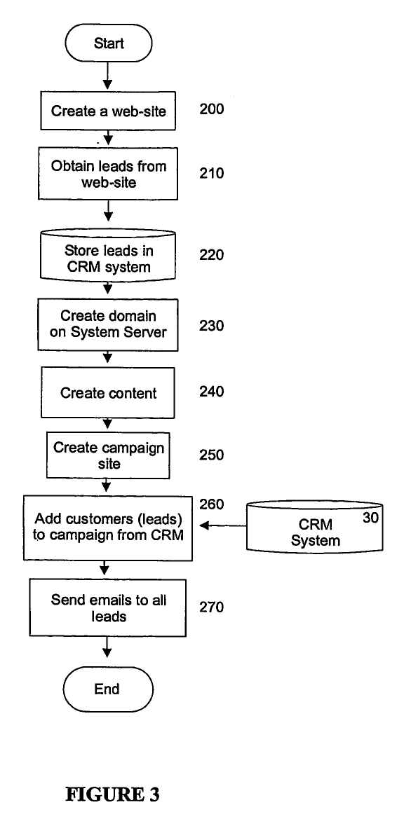

In one embodiment of the present invention, the process for the creation of a rich media sales campaign is illustrated in FIG. 3. This provides a means for the collection of a first set of parameters in order to personalise a sales campaign for a particular end user.

A sales professional begins the process enabled by this system by creating a web-site to be used in a desired sales campaign 200. The web-site can contain information on the company and the product that is associated with the particular campaign. This sales campaign web-site provides a means for identifying potential customers 210, based on their interaction therewith in addition to potentially collecting information relating to the potential customers, enabling subsequent customisation of sales campaign. These potential customers can be stored in the CRM system 220 for future access when a similar sales campaign is initiated. A potential customer may be directed to the web-site created for the particular sales campaign by a number of different avenues. For example, human interaction through technologies similar to instant messaging can be used to direct the end user to the desired web-site.

In one embodiment, this web-site can contain a form to be filled out by potential customers that desire further information regarding particular campaign. Having particular regard to this form, the customer profile fields in the form comprise but are not limited to: end user name; company, address; phone number; fax number; and email address. This particular web-site is a custom web-site for use with the sales campaign and provides a means for the collection of information relating to an end user, enabling the subsequent personalisation of a web-site for this particular end user.

The system server allows a sales professional to define a domain, or work area 230, wherein this domain consists of at least one administrator. The administrator can create sites for sales campaigns, add users or leads, delete users or leads and create event triggers. In this manner the potential customers that are associated with a particular sales campaign are identified within the domain associated with that sales campaign. Through the creation of a domain for each particular sales campaign for example, the system server can enable a sales professional to juggle multiple sales campaigns since each is essentially self contained on the system server, for example.

The next step is the creation of the content for the first iteration of the custom campaign site for the particular sales campaign 250, wherein this customisation is enabled by the information on the potential customers collected from the more general sales web-site, for example.

In one embodiment, the creation of the content for a web-site may be created by systems such as Microsoft™ Producer™ or others as would be known to a worker skilled in the art, for example Genesys™ produces content for web conferencing. When a sales campaign is to be created, a new site is developed with the look and feel of the company web-site. A form letter is entered into the system server, using the customer profile fields as previously defined. Customisation of this web-site may be provided by the system server and are those as would be know to a worker skilled in the art. For example, the customisation of a web-site for a particular customer may be provided by information collected relating to the particular users activities during interaction with the system, for example selection of a particular product or product range, thereby assisting in the identification of a users interests and/or preferences. In this manner the products and/or the presentation of information on a personalised web-site directed to this particular end user may be customised.

In step 260 leads or potential customers are added to the domain from a variety of locations including the CRM system as well as other avenues. For example, such firms as Eloqua™ provides sales leads for particular products or services in addition to others companies or mechanisms with similar capabilities as would be known to a worker skilled in the art. In this manner, a potential customer which may previously have a potential interest in the sales campaign being developed is directed to the custom web-site, thereby increasing the probability that information will be provided by the potential customer. Alternatively, a sales professional may add contact information manually, or from a Customer Relationship Management (CRM) system and these potential sales leads (end users) can also be directed to the custom web-site. For example, manual entries can be performed by a sales professional by typing their client's email address into the system server. There are a number of other avenues by which a potential customer (end user) may be directed to the intial custom web-site, for example, by a search engine wherein the end user is searching for a particular product, word of mouth or any other means as would be known to a worker skilled in the art.

In one embodiment of the invention, the events or potential customer actions which are to be monitored can be defined by a sales professional thereby enabling the tracking of what the customer has viewed. These events may include, for example, login; first click on a hyperlink; repeated clicks on the same hyperlink; logout; and/or additional information provided by a customer. The customer is alerted that their clicks may be tracked for the purpose of personalizing later interactions with a sales professional.

In one embodiment of the invention, the transfer of information relating to a customer's interaction with the system may be enabled through the use of “cookies”. A cookie, as used in network and Internet communication, is a block of data or state object that a Web server stores on a client system. When the client system accesses a Web site within a limited range of domain names, the client system automatically transmits a copy of the cookie to the Web server that serves the Web site. The cookie may include a unique cookie number corresponding to the client system. Thus, the cookie can be used to identify the client system (by identifying the Web browser) and to instruct the server to send a customized copy of the requested Web page to the Web browser.

The final step performed in this sequence of steps is for the system server to initiate the sending of emails or other types of messages, to the customers or leads in the domain 270, wherein these messages direct the customer to a rich media web-site which has been personalised for them in particular, based on the information previously collected by the system.

Communicating with Rich Media

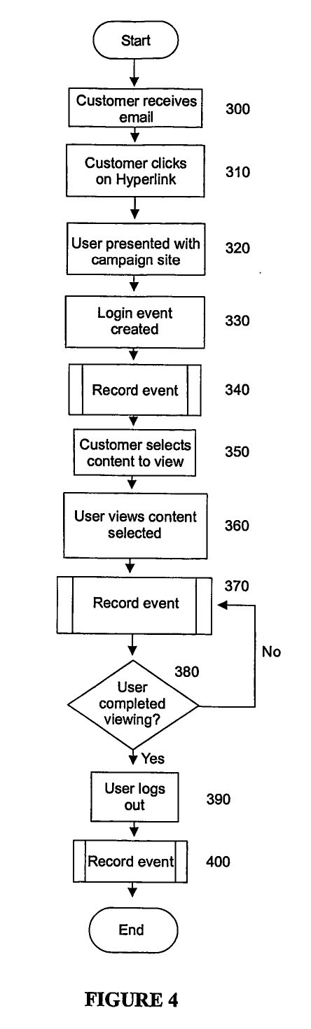

In one embodiment of the present invention, the process for communicating with rich media is illustrated in FIG. 4.

The customer receives an email or other electronic message that is sent by the system server to the desired potential customer 300, wherein this message identifies a location of a personalised web-site. In one embodiment of the invention, the email contains a hyperlink, which directs the customer to this personalised web-site. The system server creates a unique web-site for each individual, which may avoid attributions of spam, which is irrelevant or inappropriate messages to one or more newsgroups or mailing lists, for example. The customer is notified to the fact that upon clicking this hyperlink, their behaviour may be tracked for the purpose of personalising later interactions with a sales professional.

In the event that the customer chooses to click the hyperlink 310, their web browser, for example, opens the web-site personalised for them. The system of the present invention tracks events within the experience 330, which represent the interaction between the web-site and the end user, using for example the interconnection between the web browser being used by the end user and the system server, wherein appropriate configuration of these components would be known to a worker skilled in the art, for example the use of “cookies”. The events being tracked may comprise login; first click on a hyperlink; repeat clicks on the same hyperlink; logout; or other customer defined events, 340, 350, 360, and 370. At step 380, there is a determination of whether the end user is continuing to view the personalised web-site, which results in a continuation of the recordal of the events occuring as long as the viewing of the web-site by the end user continues.

Once the customer logs out of the personalised web-site 390 the system records data 400 about the event and subsequently commences the next step of processing the event data for the sales professional. The recordal of this information relating to the interaction between the end user and the system can be stored in the CRM system for future use in this particular sales campaign or for future sales campaigns, for example.

In one embodiment of the invention, follow-up interactions may occur between a sales professional and potential customers who have previously viewed their personalised web-sites and request further information. For example, a web conference between a sales professional and a customer can be set up for those who request personal interaction. This conference may be a voice call, a text exchange, an instant message, or some other kind of real time web interaction. Using this type of interaction technique, information can be reviewed simultaneously on a personalized web-site by a sales professional and the potential customer, thereby utilising the personalised web-site as common ground for this personal, remote interaction between the sales professional and the end user. Previously collected information relating to this end user during past interactions with the system may enrich, or further personalise this interaction, for example. In addition, rich media may subsequently be added to the personalised web site in order to address the customer's further inquiries, during these remote interactions, for example.

In one embodiment, further web conferences may be initiated from this personalised web-site and additional information can be posted to the personalised web-site by the sales professional or support staff, for example. Events, for example end user actions during this interaction with the system, for example web-conference sessions, can additionally be tracked, for example tracking of the customer's movement between web pages may be monitored and saved by the system, for future use to further personalise futher interactions.

Tracking Events in the Rich Media Experience

In one embodiment of the present invention, the system server automatically relays information to one or more communication systems which are used for alerting a sales professional of a end user's progress during the interaction with the personalised web-site. For example, this information may be transferred to a customer relationship management system or lead generation system. In one embodiment, all event data collected regarding a customer's viewing experience is stored on the system server.

In one embodiment, the selected or all of the collected event data or end user interactions can be transmitted to a sales professional thereby informing the sales professional of a end user's progress. This transmission of end user progress may be transferred to the sales professional in real time, thereby enabling a sales professional to remain current with respect to an end user's interaction with the system. The selection of the event data to be transmitted may be pre-selected by the appropriate sales professional. For example, a sales professional may choose only to be notified once an end user requests a web-conference. In this manner, the sales professional does not receive transmissions relating to all of an end user's actions but only ones which are determined to be significant by the sales professional, for example. In one embodiment of the present invention a sales professional may select the transmission method by which this information is to be sent, for example using a cell-phone, email, Blackberry™, pager or other device as would be known to a worker skilled in the art.

The identity of all leads or customers and the information collected during an end user's interaction with the system are forwarded to the CRM system and/or lead generation system. In the case that a particular end user does not exist within the CRM system, a new lead therefor is created. In the case that the end user exists within the CRM system, due to previous interactions between the end user and the system, the continued use of the system by this particular end user is appended to this end user file and stored in the CRM system.

In one embodiment, the CRM system may add user profile information to the event data collected by the present invention. This enhanced data file can in turn be loaded into the domain created by the system server for a sales professional.

In one embodiment of the invention, the CRM system can be the sales professional's primary interface with data collected by the system according to the present invention. This information enables the personalisation of interactions between a sales professional and an end user thereby improving the potential for a sale due to the more strategic distribution of a sales campaign.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A method for generating a personalised sales web-site for an end user, said method comprising the steps of:
a) generating a custom web-site for a particular sales campaign, said custom web-site enabling electronic access by the end user;
b) collecting and storing one or more first events, said first events defining the end user's interaction with the custom web-site;
c) generating a personalised sales web-site, said personalised sales web-site being a web-site created according to parameters based on the collected first events and the particular sales campaign;
d) sending a message including an identifier to the end user, said identifier enabling the end user to locate the personalised sales web-site, the end user subsequently being able to electronically access the personalised sales web-site; and
e) collecting and storing one or more second events, said second events defining the end user's interaction with the personalised sales web-site;
wherein the collected and stored first and second events can be used to generate a second personalised sales web-site.

2. The method according to claim 1, wherein the custom web-site or the personalised sales web-site or both, comprise rich media content.

3. The method according to claim 1, wherein end user interaction with the custom web-site and the personalised sales web-site occurs via a global communication network.

4. The method according to claim 3, wherein the global communication network is the Internet.

5. The method according to claim 1, wherein the identifier is a hyperlink.

6. The method according to claim 1, wherein the end user is identified by an email address or other personal identifier.

7. The method according to claim 1, wherein said first events further comprise personal end user information.

8. A system for generating a personalised sales web-site for an end user, said system comprising:
a) means for generating a custom web-site for a particular sales campaign, said custom web-site enabling electronic access by the end user;
b) means for collecting and storing one or more first events, said first events defining the end user's interaction with the custom web-site;
c) means for generating a personalised sales web-site, said personalised sales web-site being a web-site created according to parameters based on the collected first events and the particular sales campaign;
d) means for sending a message including an identifier to the end user, said identifier enabling the end user to locate the personalised sales web-site, the end user subsequently being able to electronically access the personalised sales web-site; and
e) means for collecting and storing one or more second events, said second events defining the end user's interaction with the personalised sales web-site;
wherein the collected and stored first and second events can be used to generate a second personalised sales web-site.

9. The system according to claim 8, wherein a central relationship system provides a means for storing said first and second events.

10. The system according to claim 9, wherein the central relationship system provides means for identifying an appropriate end user for the particular sales campaign.

11. The system according to claim 8, wherein the means for sending is a streaming system that provide for the transmission of information to the end user via a global communication network.

12. The system according to claim 11 wherein the global communication network is the Internet.

13. The system according to claim 8, further comprising a web conferencing system thereby enabling a personal remote interaction between a sales professional and the end user.

14. The system according to claim 8, wherein the end user is identified by a personal identifier.

15. The system according to claim 14, wherein the personal identifier is an email address.

16. The system according to claim 8, wherein the identifier is a hyperlink.

17. The system according to claim 8, wherein the custom web-site or the personalised web-site or both comprise interactive components, said interactive components enabling integration of personalised information into the web-site prior to viewing by the end user.

18. A computer readable medium containing program instructions for execution on a computer system, which when executed by the computer system causes the computer system to perform method steps for delivering, via a global communication network, a personalised sales web-site to an end user, said method comprising the steps of:
a) generating a custom web-site for a particular sales campaign, said custom web-site enabling electronic access by the end user;
b) collecting and storing one or more first events, said first events defining the end user's interaction with the custom web-site;
c) generating a personalised sales web-site, said personalised sales web-site being a web-site created according to parameters based on the collected first events and the particular sales campaign;
d) sending a message including an identifier to the end user, said identifier enabling the end user to locate the personalised sales web-site, the end user subsequently being able to electronically access the personalised sales web-site; and
e) collecting and storing one or more second events, said second events defining the end user's interaction with the personalised sales web-site;
wherein the collected and stored first and second events can be used to generate a second personalised sales web-site.
